(19) United States
(12) Patent Application Publication
(10) Pub. No.: US 2011/0001381 A1
(43) Pub. Date: Jan. 6, 2011

(54) McDaniel magnet motor

(76) Inventor: Scott L. McDaniel, Columbus, IN (US)

Correspondence Address: Scott L. McDaniel, 1883 W. Shady lane, Columbus, IN, 47201, US

(21) Appl. No.: 12/459,652

(22) Filed: Jul. 6, 2009

(51) Int. Cl. H02K 21/00; H02K 7/06

(52) U.S. Cl. 310/152; 310/20

(57) ABSTRACT

A hybrid magnet motor that utilizes two reciprocating magnet head pistons that are 180 (degrees) out of sync., in which acts against a rotating dual polarity magnet wheel (5) which causes a repulsion for the first 180 (degrees) of rotation, then an attraction for the second 180 (degrees) of rotation, when the magnet head piston reaches about 67.5 (degrees) Before-top-dead-center. A timing disk (15) triggers on the appropriate sensor, in which activates or energizes that particular electromagnetic coil, and causes the magnet head piston in question to rotate past the pistons stall out point, which is when the magnet head piston is at its Top-dead-center, or its magnet head piston is closest to the magnet wheel (5). This is the cylinders closest and strongest point of attraction. As the magnet head piston is caused to rotate further After-top-dead-center to about 22.5 (degrees), the timing disk (15) causes the electromagnetic coil to be de-energized, which the piston in question starts its repulsion stroke, in which power and rotational torque can be extracted from the motor. Cylinder two (34) acts the same way as cylinder one (8) except its 180 (degrees) out of sync. Giving a 100% increase in efficiency.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

Not Applicable

2. Prior Art

Not Applicable

### OBJECTS AND ADVANTAGES

The present invention uses the natural powers of magnets, which are known to either repel other magnets of like polarity or attract of opposite polarity, and also attract iron and tin metals as well. But yet some metals can be used to allow magnetic influence to pass thru without resistance. This invention makes the magnets counteract on each other with proper polarity, and also using a controlled electromagnet of specific timing, a rotational force or torque can be produced and extracted from the magnets.

### SUMMARY OF THE INVENTION

The primary object of the present invention is utilizing a new untapped source of power in the field of magnetics. Through the use of certain materials, mediums and design structure the force of magnets can be put to work. This magnet motor of simple design and few moving parts was designed for the low voltage 12V automotive systems, but could just as easily be designed for higher voltage and power requirements too.

This motor acts very much just like a D.C. motor but only uses input power 25% of the time. Another important object of the invention is that it is environmentally friendly, it does not give off any hazardous by-products of any kind, It doesn't depend on burning any combustible gases or air so there's no toxic fumes or noise pollution to deal with. It doesn't depend on generating any high voltages, so there aren't any safety concerns to keep from getting shocked.

A further object of the invention is that it uses components to help recover spent energy, and also any energy that might be possibly generated, while at the same time protecting those components vulnerable to internally generated voltage spikes. These and other objects and advantages of the present invention will become apparent from the following detailed description of the preferred embodiment thereof, with reference to the accompanying drawings.

### BRIEF DESCRIPTION OF THE DRAWINGS

FIG. 1 This is a perspective side view of the mechanical embodiment.

FIG. 2 This is the schematic diagram of the power supply, sensing, controlling and output pulsing circuitry.

FIG. 3 Is a full-size perspective bottom view of the magnet wheel.

FIG. 4 This is a perspective side view of the timing sensors and timing controls, with the timing disk in between, that may be embodied.

### DRAWINGS-REFERENCE NUMERALS

| | | | |
|---|---|---|---|
| 1 | mounting bracket | 2 | coil one |
| 3 | coil two | 4 | cores |
| 5 | magnet wheel | 6 | spacing |
| 7 | piston one | 8 | cylinder one |
| 9 | piston two | 10 | 45(degree) angle gear |
| 11 | mounting supports | 12 | steel collars |
| 13 | sensor one | 14 | sensor two |
| 15 | timing disk | 16 | timing control |
| 17 | timing control | 18 | connecting rod |
| 19 | connecting rod | 20 | shaft |
| 21 | timing line | 22 | “S” polarity |
| 23 | “N” polarity | 24 | washers |
| 25 | slide | 26 | machine screw |
| 27 | machine screw nuts | 28 | knob |
| 29 | mounting base | 30 | ON point |
| 31 | OFF point | 32 | window area |
| 33 | black shaded area | 34 | cylinder two |
| 35 | steel connecting rod pin | 36 | mounting |
| 37 | crankshaft | 38 | housing |
| IC1 | adjustable voltage | IC2 | fixed positive voltage regulator |
| | regulator | | |
| IC3 | voltage comparator | IC4 | cmos hex inverter |
| Q1 | series pass regulator | Q2 | P-CH MOSFET |
| Q3 | N-CH MOSFET | Q4 | P-CH MOSFET |
| Q5 | N-CH MOSFET | V1 | +12 V power source |

sensor one opto-isolator interrupter module
sensor two opto-isolator interrupter module

### DETAILED DESCRIPTION—OF THE PREFERRED EMBODIMENT

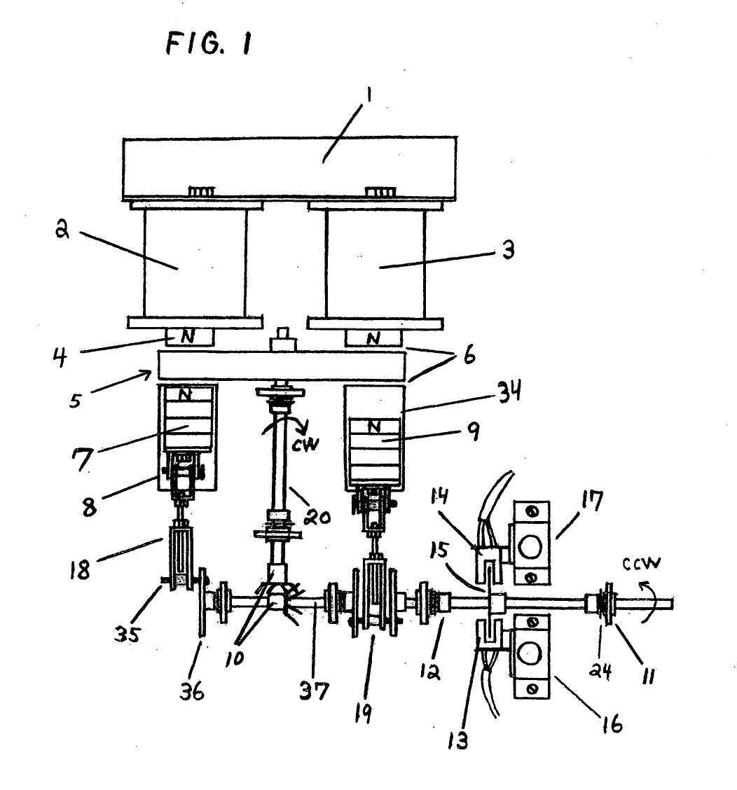

With reference to the drawing of FIG. 1 mounting bracket 1 made from 1.5″×1.5″ aluminum at 90 (degree) angle at 6″ long, supports electromagnet coil one 2 and electromagnet coil two 3 over top of the magnet wheel 5. Both, coil one 2 and coil two 3 were designed for about 40 watts each to match the estimated magnetic power of the magnet head pistons, piston one 7 and piston two 9. The electromagnet coil bobbins are fabricated of a 3″ long plastic pvc pipe schedule 40 with a 1″ inside dia. and the end plates are made from 3″ dia. circle of 3/16″ thick basswood or plastic, with the center drilled out to fit over the plastic pipe ends, then cemented into place. Coil one 2 and coil two 3 are wound with 355 feet of #20 A.W.G. copper wire designed for about 305 cm/A. Cores 4 is made from 1″ dia. solid iron at 3¼″ long with the mounting end drilled and tapped to fit a no. 20 thread, ¼″ dia. at ½″ long mounting bolt.

The cores 4 dia. was used to match the diameter of piston one 7 and piston two 9. Both, coil one 2 and coil two 3 hang over top of magnet wheel 5 with a 1/16″ to a ⅛″ spacing 6 between cores 4 and magnet wheel 5. The magnet wheel 5 rotates horizontally at a right angle forming a 90 (degree) angle to the coil one 2, and coil two 3, and at a right angle to the magnet head piston one 7 and magnet head piston two 9. Cylinder one 8 is positioned vertically below the magnet wheel 5 in alignment with coil one 2, also separated by a 1/16″ to a ⅛″ spacing 6. And the same as cylinder two 34, is positioned vertically below the magnet wheel 5 in alignment with coil two 3, and separated by a 1/16″ to a ⅛″ spacing 6. The magnet wheel 5 shaft 20 runs parallel to cylinder one 8 and cylinder two 34, and is fitted with a 45 (degree) angle gear 10, which is at the end of its shaft 20.

Piston one 7 is comprised of four 1⅛″ dia. magnets with a hole in its center of ⅜″ dia. with each magnet ¼″ thickness. All four magnets are fused or cemented together to make one single body in alignment. so to slide easily through cylinder one 8 with polarity “N” facing toward the end of the cylinder one 8, toward magnet wheel 5. Piston two 9 is also comprised of four 1⅛″ dia. magnets with a hole in its center of ⅜″ dia., and with each magnet ¼″ thickness. All four magnets are fused or cemented together in alignment so to slide easily through cylinder two 34, with polarity “N” facing toward the end of the cylinder two 34, toward magnet wheel 5. Piston one 7, its connecting rod 18 is firmly mounted to the magnet head of piston one 7. The other end of connecting rod 18 is positioned on a 3/16″ dia. by 11/16″ long, steel connecting rod pin 35, or a 3/16″ dia. by 11/16″ steel hollow tube, tapped and drilled for a #6-32 machine screw 26 at 1 3/16″ long, secured or fused to the crankshaft 37 mounting 36. This is made from a 2″ dia. steel disk washer, with a 7/16″ dia. steel collars 12 and 3/16″ dia. hole.

The connecting rod pin 35 is offset by ½″ to allow piston one 7, a stroke of 1″ travel. Piston two 9 and connecting rod 19 is made the same way as piston one 7 and connecting rod 18, but it is positioned 180 (degrees) out of sync. from piston one 7, and at its furthest end of stroke of 1″. The connecting rod 18 and connecting rod 19 are connected together through a 3/16″ dia. steel crankshaft 37. In the middle of the crankshaft 37 is fitted with a 45 (degree) angle gear 10, positioned as shown with the 45 (degree) angle gear 10 at the end of the magnet wheel 5 shaft 20, so as to position the magnet wheel 5 shaft 20 perpendicular at a 90 (degree) angle from the crankshaft 37.

Crankshaft 37 is held in position from mounting supports 11, which holds the crankshaft 37 in place from any side to side movement. Washers 24 are added to reduce wear. Cylinder one 8 and cylinder two 34 are 2⅝″ long and 1⅛″ clearance inside dia., made of plastic, or aluminum, or other material that does not make the magnet heads pistons cling to the sides of the walls producing drag, this is of an air cooled design. On the other side of connecting rod 19 is the top view of the timing control 16, with sensor one 13, and the timing control 17, with sensor two 14. In between sensor one 13 and sensor two 14 is the timing disk 15, which is secured to the crankshaft 37 so when the crankshaft 37 rotates, the timing disk 15 rotates in the same amount of degrees. Mounting supports 11 and collars 12 are used to brace crankshaft 37 and magnet wheel 5 shaft 20 from moving out of position, or any side to side moving. Referring to FIG. 4 timing control 16, which has an “E” shaped body and has a #6-32 machine screw 26, with a knob 28 on top, centered through its body, held in position with two #6-32 machine screw nuts 27. In turning the knob 28, moves a slide 25 that sensor one 13 is fastened to, which gives sensor one 13 an up and down movement range. A mounting base 29 attached to the timing control 16 holds it firmly in position from movement. Timing control 17 is made exactly as described for timing control 16, and controls sensor two 14. It is positioned on the opposite side of the timing disk 15, being 180 (degrees) out of sync.

Timing disk 15 with a dia. of approx. 1⅛″, which can be made of plastic, metal, or magnetic material is sandwiched in between the grooves of sensor one 13 and sensor two 14. And a collars 12 is cemented or fused to the timing disk 15 to secure it to the crankshaft 37 with a set screw. Sensor one 13 and sensor two 14 are opto-isolator interrupter modules, consisting of infrared diodes and photo transistors. The timing disk 15 has a window area 32 of 25%, this can be a clear plastic area or a cutout opening.

The black shaded area 33 covers 75% of the timing disk 15, any time sensor one 13 or sensor two 14 is in the window area 32, infrared light will be allowed to pass through to the opto transistor part of the module. A ON point 30 line starts the on time, and a OFF point 31 line starts the off time, going in a clockwise (CW) rotation.

The magnet wheel 5 consists of sixteen magnets, with each magnet 1⅛″ dia. at ¼″ thick, each magnet position is two deep making a depth of ½″, they are cemented or fused together to make a single body. Half the wheel is a “S” polarity 22, the other half is a “N” polarity 23, a center line is the timing line 21. The magnet wheel 5 housing 38 has to be made from some material, like aluminum or copper that does not block or shield the magnetic flux lines that are concentrated from coil one 2 or coil two 3. To find the diameter of the magnet wheel 5, take the diameter of piston one 7, and multiply by 3.612. Example 1.125″×3.612=4.0635″, also, you can take the diameter of piston one 7, and use eight magnets all formed in a circle butt to butt to find the diameter needed. On the outside diameter of magnet wheel 5, is a outer band made of the same material as the housing 38 to firmly hold all “S” magnets 22, and all “N” magnets 23 from throw out by centrifugal force. All “S” magnets 22 and all “N” magnets 23 must be firmly secured to the disk housing 38. Collars 12 can be made from steel for strength, using either a set screw or keyway to lock the magnet wheel 5 in to place. To mechanically time magnet wheel 5 to cylinder one 8, timing line 21 is set at center position of cylinder one 8. While piston one 7 is at top-dead-center, or at the farthest end of cylinder one 8 closest to the magnet wheel 5, and timing disk 15 set at half way point in the window area 32.

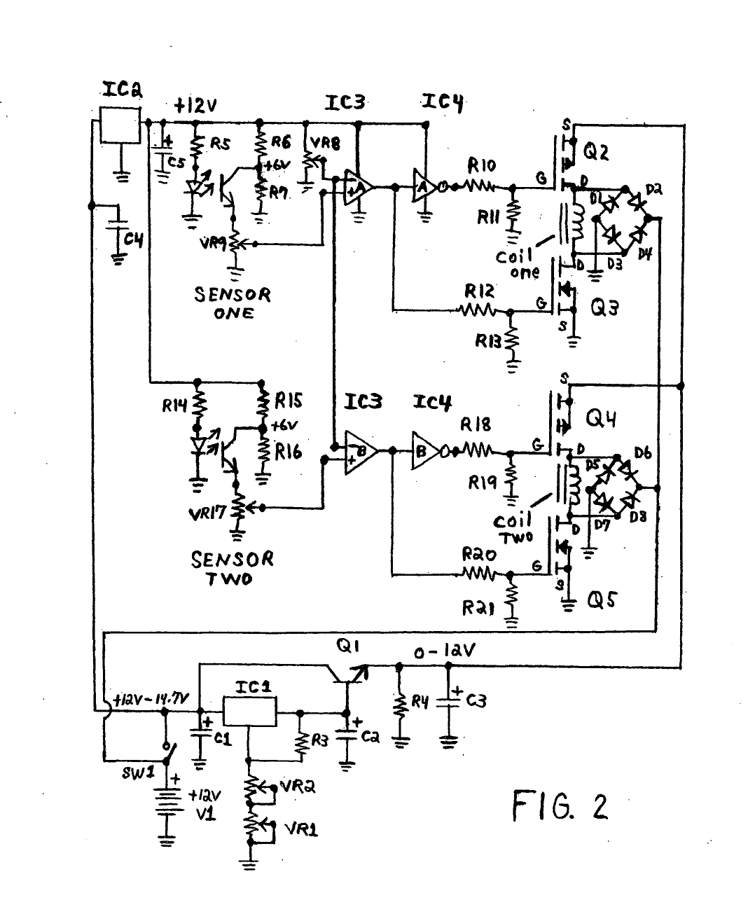

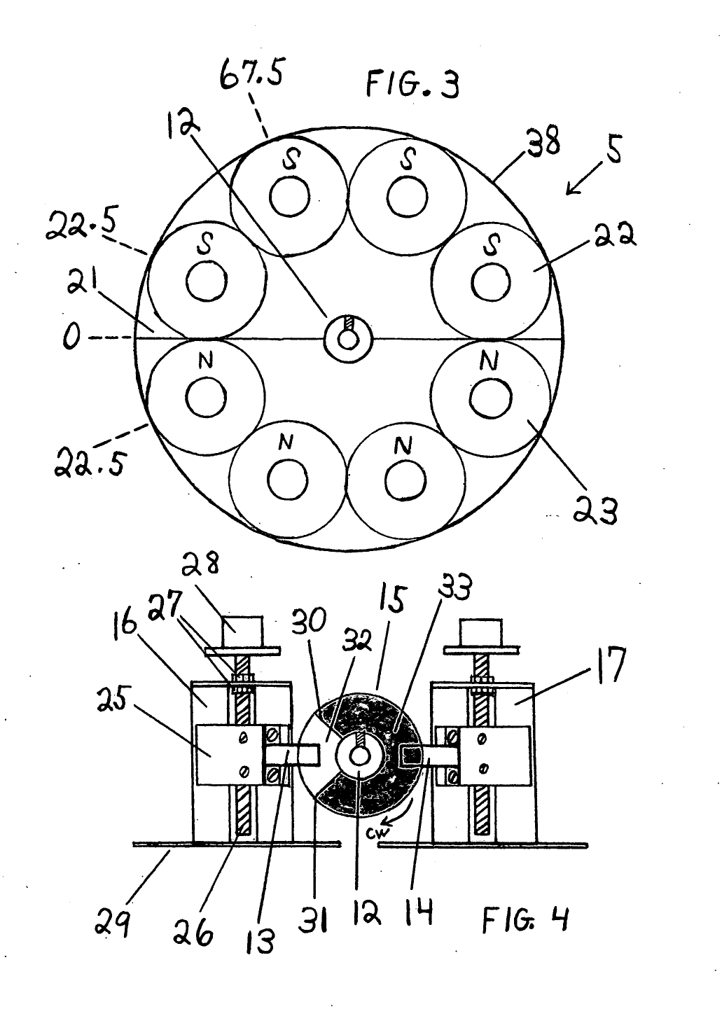

In the present invention FIG. 2, sensor one 13, sensor two 14 and the associated circuitry form the sensing function. Voltage comparator IC3 and cmos hex inverter IC4, with resistors R10-R13 and resistors R18-R21, form the controlling function. P-CH MOSFET Q2, Q4, N-CH MOSFET Q3, Q5, coil one 2 and coil two 3, form the pulsing circuitry. Adjustable voltage regulator IC1, fixed positive voltage regulator IC2, series pass regulator Q1 and associated circuitry, form the power supply. A +12V power source V1, supplies voltage to switch sw1. Upon closing switch sw1, voltage is routed to capacitors c1 and c4, which is used to filter charge pulses that return from diodes D1-D8, and any noise that might be in the circuit.

As voltage goes through a fixed positive voltage regulator IC2, it supplies a constant +12V supply or somewhat lower voltage to components C5, R5, R6, R7, VR8, IC3 and IC4, as well as R14, R15, R16. Capacitor C5 filters any noise or voltage pulses at this point in the circuit, resistors R5 and R14 are 1 k in value, limiting current through sensor one 13 and sensor two 14. Resistors R6 and R7 are 100 k in value forming a voltage divider, supplying half the supply voltage or rail voltage to the collector of the transistor in sensor one 13. When the window area 32 triggers sensor one 13, a voltage is developed at the emitter of the sensor one 13 transistor, which is connected to a variable resistor trimpot VR9. This has a value of 50 k and is adjusted to set at about 60-70 mv, and is connected to the non-inverting input of a voltage comparator IC3-A.

Variable resistor trimpot VR8 is 10 k in value, it is adjusted to put out an arbitrary reference voltage of 50 mv, to work within the parameters of both sensors, and it is connected to the inverting inputs of voltage comparator IC3-A and voltage comparator IC3-B. Resistors R15 and R16, also are 100 k in value, and they form a voltage divider supplying half the supply voltage to the collector of the transistor, in sensor two 14. If sensor one 13 is turned on, sensor two 14 is turned off, and no infrared light strikes the photo transistors base of sensor two 14.

Preventing any current to flow through 50 k, variable resistor VR17, resulting in a zero voltage at the non-inverting input of voltage comparator IC3-B. If sensor one 13 is turned on, triggers voltage comparator IC3-A output to go high. Resulting with the rail voltage of approx. +12V or thereof, which in turn is routed to resistors R12, R13 and the gate of N-CH MOSFET Q3. Resistors R12 and R13, form a voltage divider to the gate of MOSFET Q3, to provide enough bias voltage to turn on at a sufficient conduction level.

Resistor R13 is also used as a parallel input resistance to the gate of MOSFET Q3, to prevent any unwanted current flow through MOSFET Q3. When it is in a turned off condition, do to MOSFET Q3 extremely high input impedance. If comparator IC3-A output is high or +12V, it is also routed to the input of cmos hex inverter IC4-A, which is changed from a +12V to zero volts, and is routed to resistors R10, R11 and the gate of P-CH MOSFET O2.

Resistors R10 and R11, form a voltage divider that is connected to the gate of MOSFET Q2. If a zero volts is being applied to the gate of MOSFET Q2, it will turn on. The leads of coil one 2 is connected to the drains (D) of MOSFET Q2 and MOSFET Q3 in such a way, as to provide the same polarity as piston one 7 polarity, and be directed to the magnet wheel 5 as shown in FIG. 1. The source (S) lead of MOSFET Q3, is connected to ground to complete the current path, and the source lead of MOSFET Q2, is connected to the power supply output lead of series pass regulator Q1. Diodes D1-D4 form a full wave bridge configuration to capture the energy from the reversal of the magnetic field after coil one 2 was pulsed.

Diodes D1-D4 also serves to protect MOSFET Q2 and MOSFET Q3 from high voltage spikes that may be generated. Voltage Comparator IC3-B, may be in a low state at zero volts at its output pin, which is routed to resistors R20, R21 and the gate of N-CH MOSFET Q5. Resistors R20 and R21, form a voltage divider connected to MOSFET Q5, if zero volts is at the gate of MOSFET Q5, it will be turned off, thereby no current flows. Comparator IC3-B being also connected to the input of cmos hex inverter IC4-B, the output of inverter IC4-B is at the supply voltage of +12V or thereof, which is routed to resistors R18, R19 and the gate of P-CH MOSFET Q4.

Resistors R18 and R19, also form a voltage divider connected to the gate of MOSFET Q4, the positive voltage developed at the gate turns MOSFET Q4 off, preventing any current to flow through coil two 3. The leads of coil two 3 are connected to the drains (D) of MOSFET Q4 and MOSFET Q5, and having the same polarity as piston one 7 and piston two 9, and be directed as same to the magnet wheel 5. The source (S) lead of MOSFET Q5 is connected to ground to complete the current path, and the source (S) lead of MOSFET Q4 is connected to the power supply output lead Q1. Diodes D5-D8 serves the same function as Diodes D1-D4, and is also connected to the positive terminal of the +12V power source V1. Resistors R11, R13, R19 and R21 are 100 k in value ¼w, and resistors R10, R12, R18 and R20 are 39 k in value ¼w.

With switch sw1 closed, voltage is applied to the input of the voltage regulator IC1, its output lead is connected to resistor R3, capacitor C2, and the base of series pass regulator Q1. Resistor R3 is connected to the adjustable lead of voltage regulator IC1, and to variable resistor VR2, and the voltage acrossed it is held constant. Variable resistor trimpot VR2 has a value of 1 k, and is used as the idle speed adjustment, it is connected to variable resistor control VR1 with a value of 5 k, and it is used for the speed control. In which controls the voltage to the base of regulator Q1. Capacitor C2 is used to maintain stability, regulator Q1 increases the current output of voltage regulator IC1. And capacitor C3 is used to minimize any ripple voltages, noise and stabilizes the output voltage to the source leads of MOSFET Q2 and Q4. Resistor R4 serves as a bleeder to capacitor C3.

### Operation

Starting at 67.5 (degrees) ON point 30, before-top-dead-center, timing disk 15 causes P-CH MOSFET Q2 and N-CH MOSFET Q3 to turn on energizing coil one 2 while piston two 3 is nearing the end of it's repulsion stroke. Coil one 2 concentrates its magnetic field into the cores 4 producing a “N” polarity 23, repelling the “N” polarity 23 on the magnet wheel 5, causing a continuing rotation at the same time piston one 7 is in its attraction stroke pulling toward its strongest position. At 22.5 (degrees) piston one 7, is at before-top-dead-center, and at its stall out position, because of piston one 7 has an “N” polarity 23 attracting to magnet wheel 5 “S” polarity 22.

Coil one 2 is still energized and repels the “N” polarity 23 on magnet wheel 5, and also overpowers the attraction piston one 7 has to magnet wheel 5. While piston two 9, is repelled back to its furthest point of stroke, 180 (degrees) from piston one 7. As piston one 7 is rotated past 22.5 (degrees) OFF point 31, after-top-dead-center, timing disk 15 causes MOSFET Q2 and MOSFET Q3 to turn off de-energizing coil one 2. Making piston one 7 start in its repulsion stroke because of its “N” polarity 23 in close proximity to the “N” polarity 23 of magnet wheel 5. While piston two 9, is in its attraction stroke being pulled forward by magnet wheel 5. Next, while piston one 7 is nearing the end of its repulsion stroke, piston two 9 being 180 (degrees) out of phase or sync. with piston one 7, it is at it's 67.5 (degrees) ON point 30, before-top-dead-center, timing disk 15 now causes MOSFET Q4 and MOSFET Q5 to turn on energizing coil two 3. Coil two 3, concentrates its magnetic field into its cores 4 producing an “N” polarity 23 repelling the “N” polarity 23 on the magnet wheel 5, causing a continuing rotation and also piston two 9 with its “N” polarity 23 is being attracted to the “S” polarity 22 of magnet wheel 5.

At 22.5 (degrees) piston two 9, is at before-top-dead-center, and at its stall out point, because piston two 9 also has an “N” polarity 23 attracting to magnet wheel 5 “S” polarity 22. While at this position, piston one 7 is repelled back to its furthest point of stroke. The concentration of its magnetic field of “N” polarity 23 of coil two 3 overpowers the attraction of piston two 9 to magnet wheel 5, causing it to rotate further, as it rotates pass the 22.5 (degrees) OFF point 31, after-top-dead-center, timing disk 15 causes MOSFET Q4 and MOSFET Q5 to turn off de-energizing coil two 3 making piston two 9 start in its repulsion stroke, because of its “N” polarity 23 in close proximity to the “N” polarity 23 of magnet wheel 5.

While piston one 7 is in its attraction stroke being pulled forward by magnet wheel 5, in which brings piston one 7 back around to the 67.5 (degrees) starting ON point 30, of timing disk 15 making a full rotation. While I have shown and described in considerable detail what I believe to be the preferred embodiment of the invention, it will be understood that various changes may be made without departing from the broad scope of the invention as defined by the claims.

### CONCLUSION, RAMIFICATIONS, AND SCOPE

The mounting supports 11, dimensions can be made from 90 (degree) angle aluminum, standing 1⅛″ tall, ½″ long base and ¾″ wide. Measure down ⅜″ and over ¼″ and drill a ½″ hole in the 1″ section, and insert a ½″ dia.×¼″ wide Teflon bushing, drill a 3/16″ hole in center of bushing for shaft 20, or crankshaft 37. Through experimentation it has been found that having a window area 32 of 50% of the time, a current flowed of approx. 1.9 amps at 12V. Input power was 50% of the time, which was not only using more power than needed, but was causing a loss in efficiency of the rotational force of the magnets. By further reducing the window area 32 to 25% of the time, a current flowed of approx. 1 amp at 12V.

While this not only lowered the power to coil one 2 and coil two 3, it minimized only the input power needed to get past the stall out position, which is top-dead-center. Also, it maximized the efficiency of the magnetic force as piston one 7 and piston two 9 go through there cycle. Coil one 2 and coil two 3 are wound with 355 ft #20 A.W.G. copper wire, by tapping at 178 ft and 266 ft will give higher RPM rates and put more power to coil one 2 and coil two 3.

What is claimed is:

1. A hybrid magnet motor comprising, in combination:
a electromagnetic coil one and a electromagnetic coil two firmly secured by a mounting bracket in an vertical hanging position at an 90 degrees angle to a magnet wheel with a spacing of 1/16″ to ⅛″ between a cores and said magnet wheel of dual polarity rotating horizontally, with said spacing of 1/16″ to ⅛″ positioned at an 90 degrees angle to a cylinder one and a cylinder two positioned underneath vertically in alignment to;
said coil one and said coil two said cores, and positioned at the ends of the diameter of said magnet wheel, said cylinder one and said cylinder two containing magnet head pistons of said piston one and said piston two reciprocating at 180 degrees sync., in relation to said magnet wheel through a respective crankshaft by use of a two 45 degrees angle gears, and a timing disk timed to;
said crankshaft rotating in time to said piston one and said piston two, a sensor one and a sensor two both adjustable that are positioned 180 degrees apart in relation to said timing disk with said timing disk having a window area thereby triggering on or off the sensing circuitry, controlling circuitry and pulsing circuitry.

2. A hybrid magnet motor as in claim 1, wherein the magnet heads of said piston one or said piston two can be of “n” polarity or “s” polarity.

3. A hybrid magnet motor as in claim 1, wherein the said cores of said coil one and said coil two can be made of solid iron or laminated iron and be positioned as of “n” polarity or “s” polarity being the same polarity as said piston one and said piston two.

4. A hybrid magnet motor as in claim 1, wherein the said magnet wheel being of “s” polarity on one-half of the magnet wheel and an “n” polarity on the other half of the magnet wheel with the magnet or magnets being firmly secured in a said housing and the said housing made from a material that does not block or shield magnetic flux, with said housing having an outer band to protect against centrifugal force.

5. A hybrid magnet motor as in claim 4, wherein said magnet wheel rotates on a said shaft with the said magnet wheel on one end and an said 45 degrees gear on the other end of the said shaft rotating against another 45 degrees gear on the said crankshaft making a 90 degrees angle.

6. A hybrid magnet motor as in claim 1, wherein said timing disk made of plastic, metal or magnetic material and of specified timing of said window area covering a timing cycle from about 66.5 degrees before top dead center to about 22.5 degrees after top dead center representing approximately 90 degrees of cycle rotation or 25% of said window area.

7. A hybrid magnet motor in combination with power supply ic1, q1 and fixed positive voltage regulator ic2 and associated circuitry controlling the power of output pulsing circuitry of mosfet's q2 thru q5, also of fixed positive voltage regulator ic2 supplying voltage to the sensing circuitry of sensor one and sensor two and to the controlling circuitry, voltage comparators ic3 and cmos hex inverters ic4.
